(19) United States
(12) Patent Application Publication
(10) Pub. No.: US 2006/0238156 A1
(43) Pub. Date: Oct. 26, 2006

(54) Self-moving robot capable of correcting movement errors and method for correcting movement errors of the same

(75) Inventor: Sang-yun Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/318,449

(22) Filed: Dec. 28, 2005

(30) Foreign Application Priority Data
Apr. 25, 2005 (KR) 10-2005-0034123

(51) Int. Cl. B25J 5/00

(52) U.S. Cl. 318/568.12; 318/587

(57) ABSTRACT

A self-moving robot capable of correcting movement errors is provided. The self-moving robot includes a plurality of drive wheels, motors for rotating the drive wheels, drive wheel rotation detectors for detecting the amount of rotation of the drive wheels, a rotation detection unit for detecting rotation of the self-moving robot, and a controller for determining, through the rotation detection unit, whether or not the self-moving robot has deviated from a movement path and controlling the drive wheels according to the determination to correct movement of the self-moving robot for the deviation from the movement path. The self-moving robot can move along the movement path without deviation by automatically correcting the deviation that may occur during movement.

### BACKGROUND OF THE INVENTION

1. Field of the Invention

The present invention relates to a self-moving robot, and more particularly to a self-moving robot capable of correcting movement errors and a method for correcting movement errors of the self-moving robot.

2. Description of the Related Art

Robots have been developed for industrial purposes and used as part of factory automation. Robots also have been used, in place of human beings, to collect information in extreme environments that human beings cannot access. Robot technologies have been rapidly developed as applied to the most advanced space development industries. Recently, even human-friendly household robots have been developed. A typical example of the human-friendly household robot is a cleaning robot.

FIG. 1 is an external view of a general cleaning robot, and FIG. 2 shows a mechanism for moving the general cleaning robot to illustrate movement errors of the robot.

As shown in FIG. 1, first sensor units 30 are provided on front and rear portions of a robot body housing 20 of the general cleaning robot. The first sensor units 30 detect obstacles by sending ultrasonic waves and receiving ultrasonic waves reflected from obstacles. About two contact bars 31a are provided on each of the front and rear portions of the robot body housing 20 under the first sensor units 30. Transfer members 31b, which are coupled to the contact bars 31a, extend into the interior of the housing 20. The contact bars 31a are curved along an outer cylindrical surface of the housing 20. The contact bars 31a are also referred to as “contact sensors” since they sense obstacles that they directly contact.

Left and right drive wheels 40 are provided on lower left and right portions of the housing 20 of the general cleaning robot so that the cleaning robot can move freely. As shown in FIG. 2, the drive wheels 40 are rotated by left and right wheel motors 45 that are controlled by a controller 70. Encoders 47 connected to the left and right wheel motors 45 function as drive wheel rotation detectors that detect the amount of rotation of left and right drive wheels 40L and 40R and provide the detected rotation amount to the controller 70. The controller 70 can control movement of the cleaning robot by calculating a moving speed and a rotation angle θ of the robot body based on moving distances of the left and right drive wheels 40L and 40R of the cleaning robot. In FIG. 2, “SL” denotes the moving distance of the left wheel 40L, “SR” denotes the moving distance of the right wheel 40R, “r” denotes the distance from the center of rotation to the left wheel 40L, and “d” denotes the distance between the left and right wheels 40L and 40R.

However, the rotation angle θ cannot be accurately calculated since physical characteristics (for example, the distance “b” between the left and right wheels and the difference between circumferences of the drive wheels) of the same type of cleaning robot products differ slightly from each other. This results in a failure to achieve accurate straight movement of the self-moving robot.

In addition, if one drive wheel of the cleaning robot, which is to move straight, has slipped, the robot will move in a direction deviated by a certain angle from its original straight movement direction. Even if one drive wheel of the robot has slipped, the data of the amount of rotation of the left and right drive wheels applied to the controller 70 may be identical, so that the controller 70 allows the robot to continue moving along the deviated path without detecting that the robot has deviated.

Thus, there is a need to provide a new method for correcting movement errors of a self-moving robot due to different physical characteristics of the same type of robots or movement errors of the self-moving robot due to slippage or impacts during movement thereof.

### SUMMARY OF THE INVENTION

Therefore, the present invention has been made in view of the above problems, and it is an object of the present invention to provide a self-moving robot capable of correcting movement errors due to different physical characteristics of the same type of robots and a method for correcting such movement errors.

It is another object of the present invention to provide a self-moving robot capable of correcting movement errors that may occur due to slippage, external impacts, etc., and a method for correcting such movement errors.

It is yet another object of the present invention to provide a self-moving cleaning robot capable of correcting such movement errors.

In accordance with one aspect of the present invention, the above and other objects can be accomplished by the provision of a self-moving robot capable of correcting movement errors, comprising a plurality of drive wheels; a motor for rotating each of the drive wheels; a drive wheel rotation detector for detecting the amount of rotation of each of the drive wheels; a rotation detection unit for detecting rotation of the self-moving robot; and a controller for determining; through the rotation detection unit, whether or not the self-moving robot has deviated from a movement path and controlling the drive wheels according to the determination to correct movement of the self-moving robot for the deviation from the movement path.

In the self-moving robot, the rotation detection unit may be implemented using an angular rate sensor such as a gyroscope. In some cases, the rotation detection unit may be implemented using a magnetic field sensor or a 3-dimensional acceleration sensor.

Since the self-moving robot determines whether or not it has deviated from a movement path during movement and then corrects its movement for the deviation according to the determination, the self-moving robot can move in the originally intended direction without deviation, and it is also possible to automatically correct movement errors due to the slightly different physical characteristics of the same type of self-moving robot products.

In accordance with another aspect of the present invention, there is provided a method for correcting movement errors of a self-moving robot, the method comprising the steps of controlling a motor to move the self-moving robot; determining whether or not the self-moving robot has deviated from a movement path; and controlling the motor to correct movement of the self-moving robot for the deviation from the movement path if it is determined that the self-moving robot has deviated from the movement path.

In this method, the self-moving robot can move in the originally intended direction without deviation, and it is also possible to automatically correct movement errors due to the slightly different physical characteristics of the same type of self-moving robot products.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an external view of a general cleaning robot;

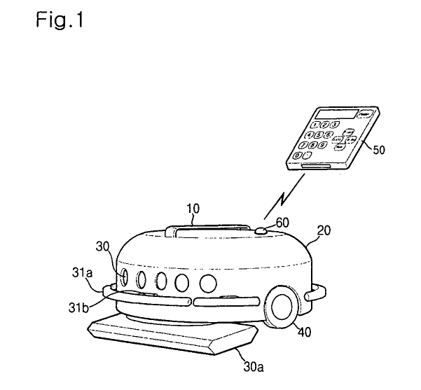

FIG. 2 shows a mechanism for moving the general cleaning robot to illustrate movement errors of the robot;

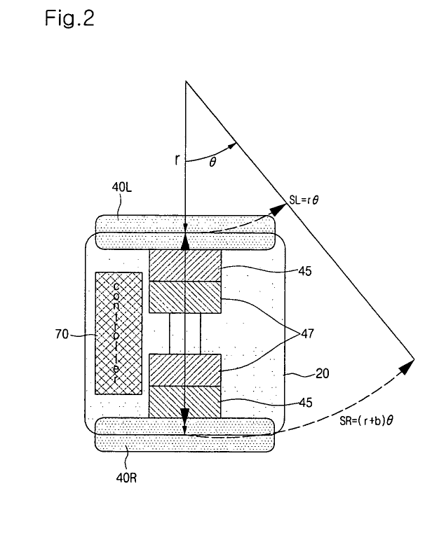

FIG. 3 is a partial block diagram of a self-moving cleaning robot capable of correcting movement errors according to an embodiment of the present invention;

FIG. 4 is a flow chart of a movement error correction method according to an embodiment of the present invention; and

FIG. 5 illustrates a straight movement path of a self-moving robot to show how movement errors are corrected in the self-moving robot according to the embodiment of the present invention.

### DESCRIPTION OF THE PREFERRED EMBODIMENTS

Now, preferred embodiments of the present invention will be described in detail with reference to the accompanying drawings. In the following description of the present invention, a detailed description of known functions and configurations incorporated herein will be omitted when it may obscure the subject matter of the present invention.

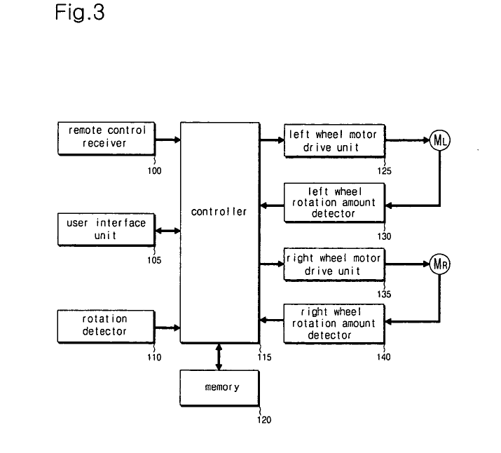

FIG. 3 is a partial block diagram of a self-moving cleaning robot that is an example of a self-moving robot capable of correcting movement errors according to an embodiment of the present invention.

As shown in FIG. 3, as with the general self-moving cleaning robot, the self-moving cleaning robot capable of correcting movement errors according to the embodiment of the present invention includes a remote control receiver 100 for receiving a remote control signal and a user interface unit 105 that includes a plurality of operating buttons and a display unit, an operating status LED, or the like for displaying operating states of the self-moving robot. Through the user interface unit 105, a user can manually control the self-moving cleaning robot and visually check operating states of the self-moving cleaning robot.

The self-moving cleaning robot according to the embodiment of the present invention further includes a rotation detector 110 for detecting rotation of the self-moving robot. The rotation detector 110 can be implemented using an angular rate sensor such as a gyroscope or using a magnetic field sensor capable of detecting azimuth. The rotation detector 110 can also be implemented using a 3-dimensional acceleration sensor that has recently attracted much attention in the field of mobile communication terminals.

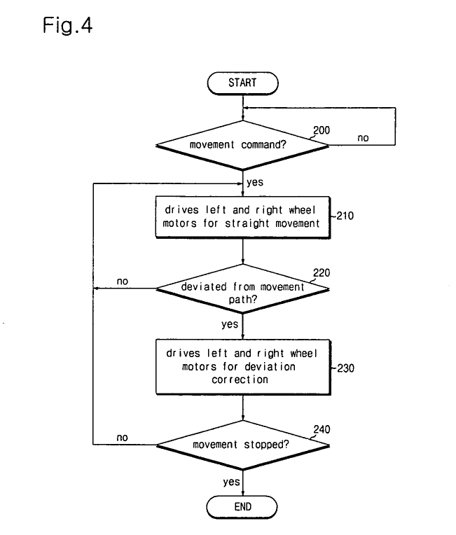

The self-moving cleaning robot according to the embodiment of the present invention also includes a main body controller (hereinafter referred to as a controller) 115 that controls the overall operation of the self-moving robot based on control program data stored in a memory 120. For example, the controller 115 monitors a signal received through the rotation detector 110 to determine whether or not the self-moving robot has deviated from a movement path and controls drive wheels to correct the movement of the self-moving robot for the deviation according to the determination. This procedure will be described in detail later with reference to FIG. 4.

As with the general self-moving cleaning robot, the self-moving cleaning robot according to the embodiment of the present invention basically includes left and right wheel motor drive units 125 and 135 and left and right wheel rotation amount detectors (specifically, rotation counters) 130 and 140 in addition to the above components. The left and right motor drive units 125 and 135 drive left and right motors M_{L} and M_{R} according to drive control signals received from the controller 115. The left and right rotation amount detectors 130 and 140, which are coupled respectively to left and right wheels, detect the number of rotations of the left and right wheels and transfer the detected rotation number data to the controller 115. If the rotation number data transferred from the left rotation amount detector 130 is identical to that from the right rotation amount detector 140, the controller 115 determines that the self-moving robot is moving straight.

The memory 120 includes an area for storing control program data for controlling the self-moving robot and an area for temporarily storing data produced during the control operation.

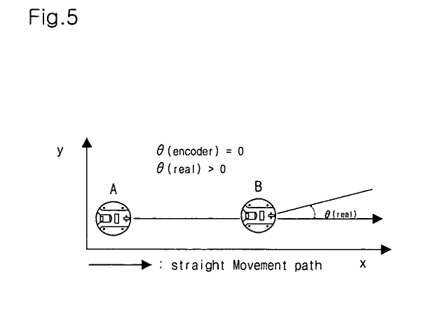

A description of how the self-moving cleaning robot configured as described above corrects movement errors will now be given with reference to FIGS. 4 and 5.

FIG. 4 is a flow chart of a movement error correction method according to an embodiment of the present invention, and FIG. 5 illustrates a straight movement path of the self-moving robot to show how movement errors are corrected in the self-moving robot according to the embodiment of the present invention.

As shown in FIG. 4, first, when a movement command is received through the remote control receiver 100 (step 200), the controller 115 of the self-moving cleaning robot controls the left and right wheel motor drive units 125 and 135 in response to the movement command to move the self-moving robot straight (step 210). While the self-moving robot moves straight, the controller 115 determines, through the rotation detector 110, whether or not the self-moving robot has deviated from the movement path (step 220).

In one method of determining whether or not the self-moving robot has deviated from the movement path, previous and current output values of the rotation detector 110 are compared, and it is determined that the self-moving robot has deviated from the movement path if the difference between the previous and current output values exceeds a predetermined threshold.

In another method, it is determined whether or not the self-moving robot has deviated from the movement path using not only the output values of the rotation detector 110 but also output values of the left and right wheel rotation amount detectors 130 and 140. Specifically, the controller 115 determines a first rotation angle θ of the self-moving robot from the movement direction using the rotation number data obtained by the left and right rotation number detectors 130 and 140. The controller 115 also determines a second rotation angle θ′ based on the difference between previous and current output values of the rotation detector 110 and sets the difference of the second rotation angle θ′ from the first rotation angle θ as an error value. If the set error value exceeds a predetermined threshold, the controller 115 determines that the self-moving robot has deviated from the movement path. The latter method is better than the former method in terms of accuracy.

If it is determined that the self-moving robot has deviated from the movement path according to any one of the above methods, the controller 115 proceeds to step 230 to control the operation of the left and right wheel motors in order to correct the rotation angle θ of the self-moving robot for the error value due to the deviation.

For example, if the rotation angle θ is calculated at “0” when the self-moving robot passes through a position A but the self-moving robot has deviated from the straight movement path by a rotation angle “θ(real)” due to slippage or external impacts when the self-moving robot passes through a position B as shown in FIG. 5 and if the deviated rotation angle “θ(real)” exceeds a threshold value, the controller 115 increases the number of rotations of the left wheel of the self-moving cleaning robot to correct the movement of the self-moving robot for the rotation angle “θ(real)” deviated from the straight movement path.

Accordingly, the self-moving cleaning robot according to the embodiment of the present invention can move straight in the originally intended direction.

As is apparent from the above description, a self-moving robot according to the present invention determines whether or not it has deviated from a movement path during movement and then corrects its movement for the deviation according to the determination. Accordingly, the self-moving robot can move in the originally intended direction without deviation. It is also possible to automatically correct movement errors due to the slightly different physical characteristics of the same type of self-moving robot products.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A self-moving robot capable of correcting movement errors, comprising:
a plurality of drive wheels;
a motor for rotating each of the drive wheels;
a drive wheel rotation detector for detecting the amount of rotation of each of the drive wheels;
a rotation detection unit for detecting rotation of the self-moving robot; and
a controller for determining, through the rotation detection unit, whether or not the self-moving robot has deviated from a movement path and controlling the drive wheels according to the determination to correct movement of the self-moving robot for the deviation from the movement path.

2. The self-moving robot according to claim 1, wherein the rotation detection unit is an angular rate sensor.

3. The self-moving robot according to claim 2, wherein the angular rate sensor is a gyroscope.

4. The self-moving robot according to claim 1, wherein the rotation detection unit is a magnetic field sensor.

5. The self-moving robot according to claim 1, wherein the rotation detection unit is a 3-dimensional acceleration sensor.

6. The self-moving robot according to claim 1, wherein the controller determines whether or not the self-moving robot has deviated from the movement path, while the self-moving robot moves straight, and controls the drive wheels to correct the movement of the self-moving robot for the deviation from the movement path.

7. A self-moving robot capable of correcting movement errors, comprising:
a plurality of drive wheels;
a drive wheel rotation detector for detecting the amount of rotation of each of the drive wheels;
a rotation detection unit for detecting rotation of the self-moving robot; and
a controller for comparing an output value of the drive wheel rotation detector and an output value of the rotation detection unit to determine whether or not the self-moving robot has deviated from a movement path and controlling the drive wheels to correct movement of the self-moving robot for the deviation from the movement path when the self-moving robot has deviated from the movement path.

8. The self-moving robot according to claim 7, wherein the controller determines whether or not the self-moving robot has deviated from the movement path, based on the difference between a first rotation angle of the self-moving robot from a movement direction thereof, output from the drive wheel rotation detector, and a second rotation angle of the self-moving robot from the movement direction, obtained based on the difference between previous and current output values of the rotation detection unit.

9. The self-moving robot according to claim 8, wherein the controller sets the difference between the first and second rotation angles as an error value, compares the error value with a preset threshold value, and determines that the self-moving robot has deviated from the movement path when the error value exceeds the threshold value.

10. The self-moving robot according to claim 9, wherein the controller controls the drive wheels to correct the movement of the self-moving robot for the error value, which corresponds to a rotation angle deviated from the movement path, when it is determined that the self-moving robot has deviated from the movement path.

11. The self-moving robot according to claim 7, wherein the rotation detection unit includes an angular rate sensor.

12. The self-moving robot according to claim 11, wherein the angular rate sensor includes a gyroscope.

13. The self-moving robot according to claim 7, wherein the rotation detection unit includes a magnetic field sensor.

14. The self-moving robot according to claim 7, wherein the rotation detection unit includes a 3-dimensional acceleration sensor.

15. A method for correcting movement errors of a self-moving robot, the method comprising the steps of:
a) controlling a motor to move the self-moving robot;
b) determining whether or not the self-moving robot has deviated from a movement path; and
c) controlling the motor to correct movement of the self-moving robot for the deviation from the movement path if it is determined that the self-moving robot has deviated from the movement path.

16. The method according to claim 15, wherein the step b) includes the step of:
d) determining whether or not the self-moving robot has deviated from the movement path, based on an output value of a rotation detection unit including one of an angular rate sensor, a magnetic field sensor, and a 3-dimensional sensor.

17. The method according to claim 15, wherein the step b) includes the step of:
e) determining whether or not the self-moving robot has deviated from the movement path, based on comparison between an output value of a drive wheel rotation detector that detects the amount of rotation of a plurality of drive wheels and an output value of a rotation detection unit including one of an angular rate sensor, a magnetic field sensor, and a 3-dimensional sensor.

18. The method according to claim 17, wherein the step e) includes the step of:
f) determining whether or not the self-moving robot has deviated from the movement path, based on the difference between a first rotation angle of the self-moving robot from a movement direction thereof, output from the drive wheel rotation detector, and a second rotation angle of the self-moving robot from the movement direction, obtained based on the difference between previous and current output values of the rotation detection unit.

19. The method according to claim 18, wherein the step f) includes the step of:
g) setting the difference between the first and second rotation angles as an error value, comparing the error value with a preset threshold value, and determining that the self-moving robot has deviated from the movement path when the error value exceeds the threshold value.

20. The method according to claim 19, wherein the step c) includes the step of:
h) controlling the drive wheels to correct the movement of the self-moving robot for the error value, which corresponds to a rotation angle deviated from the movement path, when it is determined that the self-moving robot has deviated from the movement path.
